(19) United States
(12) Patent Application Publication
(10) Pub. No.: US 2021/0157969 A1
(43) Pub. Date: May 27, 2021

(54) INFORMATION PROCESSING SYSTEM, INFORMATION PROCESSING APPARATUS, AND NON-TRANSITORY COMPUTER READABLE MEDIUM STORING PROGRAM

(71) Applicant: FUJI XEROX CO., LTD., Tokyo (JP)

(72) Inventor: Yohei TAKATSUKA, Kanagawa (JP)

(73) Assignee: FUJI XEROX CO., LTD., Tokyo (JP)

(21) Appl. No.: 16/846,382

(22) Filed: Apr. 12, 2020

(30) Foreign Application Priority Data
Nov. 21, 2019 (JP) 2019-210345

(51) Int. Cl. G06F 40/103

(52) U.S. Cl. CPC G06F 40/103

(57) ABSTRACT

An information processing system includes an information acquisition section that acquires, for each of plural times of changes performed on a document, information about a time, at which a change is performed, and an amount of the change; and a screen generation section that generates a screen in which information about each of the plural times of changes is displayed on a two-dimensional area using the time and the amount of change as axes.

### CROSS-REFERENCE TO RELATED APPLICATIONS

This application is based on and claims priority under 35 USC 119 from Japanese Patent Application No. 2019-210345 filed Nov. 21, 2019.

### BACKGROUND

### (i) Technical Field

The present invention relates to an information processing system, an information processing apparatus, and a non-transitory computer readable medium storing a program.

### (ii) Related Art

JP2002-312352A discloses a configuration including a history document storage section that stores a history document having history data for each document, a time-series order analysis section that analyzes history data between history documents specified by a user in a time-series order, a time-series-order combination and display section that combines and displays in a time-series order, on a calendar, the history documents analyzed by the time-series order analysis section in a time-series order.

### SUMMARY

In a case where a plurality of times of changes is performed on a document and it is possible to present transition of the change to a user, convenience of the user who refers to the document is improved.

Here, although it is possible to present the transition of the change in the document by, for example, presenting a specific numerical value indicating the amount of change for each change to the user, in this case, the user recognizes only the numerical value.

Aspects of non-limiting embodiments of the present disclosure relate to enabling the transition of the change performed on the document to be more clearly conveyed to the user, compared to a case where a screen, in which only the numerical value indicating the amount of change is displayed, is generated.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including an information acquisition section that acquires, for each of a plurality of times of changes performed on a document, information about a time, at which a change is performed, and an amount of the change, and a screen generation section that generates a screen in which information about each of the plurality of times of changes is displayed on a two-dimensional area using the time and the amount of change as axes.

### BRIEF DESCRIPTION OF THE DRAWINGS

Exemplary embodiment(s) of the present invention will be described in detail based on the following figures, wherein:

FIG. 1 is a diagram illustrating an information processing system;

FIG. 2 is a diagram illustrating a configuration of a terminal device;

FIG. 3 is a diagram illustrating a configuration of an external server;

FIG. 4 is a block diagram illustrating functions included in the external server;

FIGS. 5A and 5B are diagrams illustrating processing executed by the external server;

FIG. 6 is a diagram illustrating another example of a screen generated by a screen generation unit;

FIGS. 7A and 7B are diagrams illustrating another screen generated by the screen generation unit;

FIGS. 8A and 8B are diagrams illustrating another screen generated by the screen generation unit;

FIG. 9 is a flowchart showing a flow of the above-described processing performed by the external server;

FIGS. 10A and 10B are diagrams illustrating an example of another screen generated by the screen generation unit;

FIGS. 11A and 11B are diagrams illustrating an example of another screen generated by the screen generation unit;

FIGS. 12A and 12B are diagrams illustrating an example of another screen generated by the screen generation unit;

FIGS. 13A and 13B are diagrams illustrating an example of another screen generated by the screen generation unit;

FIGS. 14A and 14B are diagrams illustrating an example of another screen generated by the screen generation unit;

FIGS. 15A and 15B are diagrams illustrating a method for calculating the amount of change in a case where a figure is changed; and

FIGS. 16A and 16B are diagrams illustrating another screen generated by the screen generation unit.

### DETAILED DESCRIPTION

Hereinafter, an exemplary embodiment of the present invention will be described in detail with reference to the accompanying drawings.

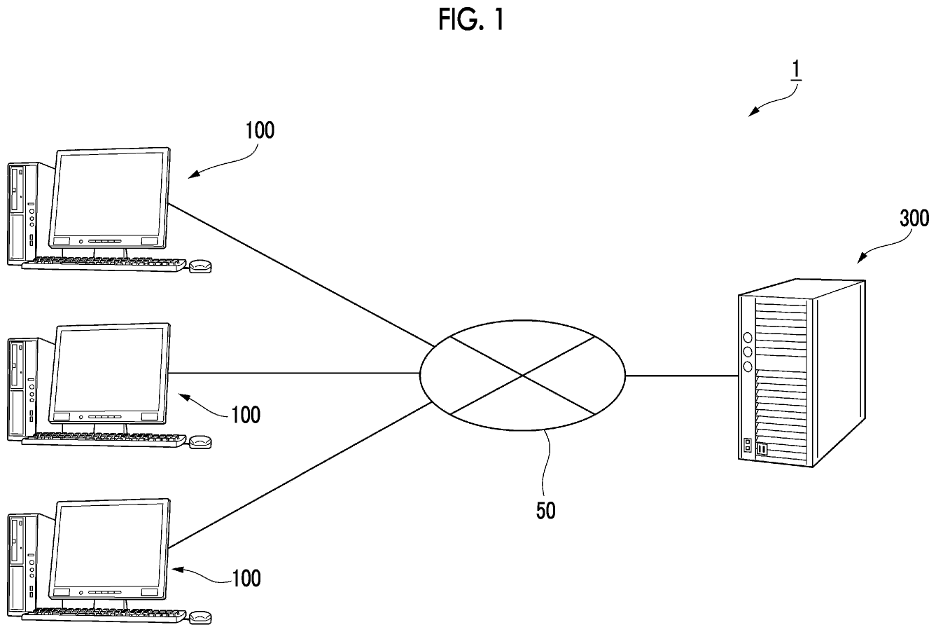

FIG. 1 is a diagram illustrating an information processing system 1 of the exemplary embodiment.

The information processing system 1 of the exemplary embodiment is provided with a plurality of terminal devices 100 operated by a user. In addition, the information processing system 1 is provided with an external server 300 that performs processing on a document.

The terminal device 100 and the external server 300 are configured by computer devices. In addition, the terminal device 100 and the external server 300 are connected to a communication line 50 such as the Internet. In the exemplary embodiment, the plurality of terminal devices 100 and the external server 300 are connected to each other through the communication line 50.

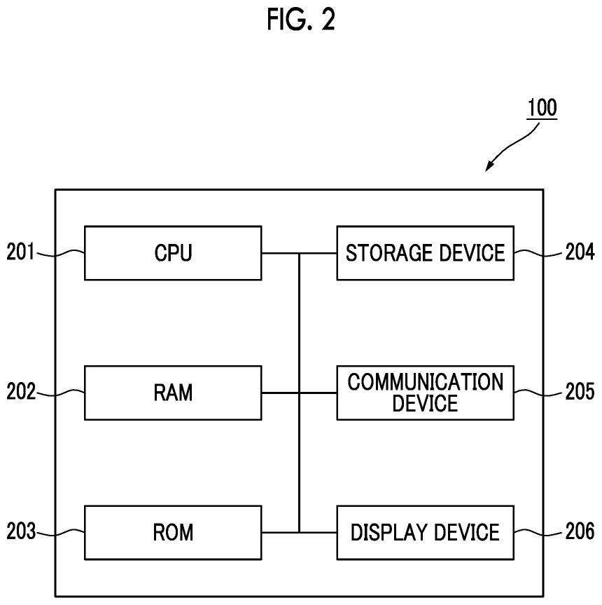

FIG. 2 is a diagram illustrating a configuration of the terminal device 100.

Each terminal device 100 includes a Central Processing Unit (CPU) 201 as an example of a processor, a Random Access Memory (RAM) 202, a Read Only Memory (ROM) 203, a storage device 204 configured by a hard disk, and the like, and a communication device (communication I/F) 205 for performing communication with an outside.

In addition, each terminal device 100 is provided with a display device 206 for displaying information. The display device 206 is configured by, for example, a liquid crystal display. In addition, although not illustrated in the drawing, the terminal device 100 is provided with input devices such as a keyboard and a mouse.

The ROM 203 and the storage device 204 store a program executed by the CPU 201. The CPU 201 reads the program stored in the ROM 203 or the storage device 204 and executes the program using the RAM 202 as a work area.

In a case where the CPU 201 executes the program stored in the ROM 203 or the storage device 204, various functions are realized.

Here, the program executed by the CPU 201 is provided to the terminal device 100 in a state of being stored in a computer-readable recording medium such as a magnetic recording medium (such as a magnetic tape or a magnetic disk), an optical recording medium (such as an optical disk), a magneto-optical recording medium, or a semiconductor memory. In addition, the program executed by the CPU 201 may be provided to the terminal device 100 using a communication unit such as the Internet.

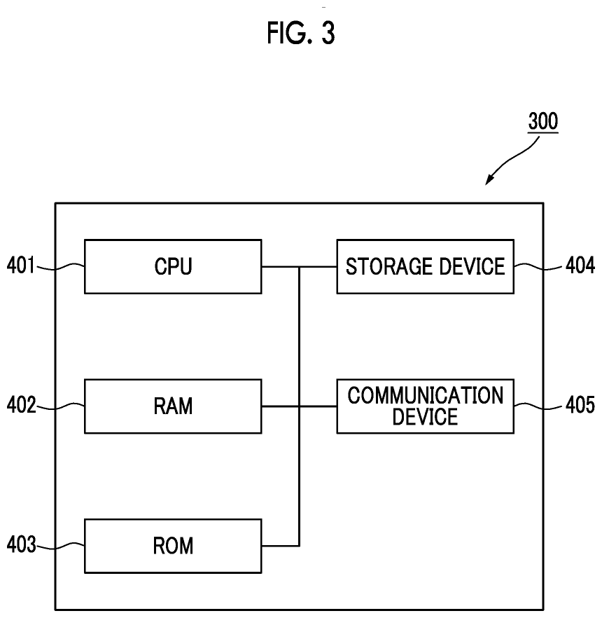

FIG. 3 is a diagram illustrating a configuration of the external server 300.

The external server 300 is provided with a Central Processing Unit (CPU) 401 as the example of the processor, a Random. Access Memory (RAM) 402, a Read Only Memory (ROM) 403, a storage device 404 configured by a hard disk and the like, a communication device (communication I/F) 405 for performing the communication with the outside.

In addition, the external server 300 is provided with the input devices, such as the keyboard and the mouse, and the display device for displaying the information, as necessary. The display device is configured by, for example, a liquid crystal display.

The ROM 403 and the storage device 404 store a program executed by the CPU 401. The CPU 401 reads the program stored in the ROM 403 or the storage device 404, and executes the program using the RAM 402 as the work area.

In a case where the CPU 401 executes the program stored in the ROM 403 or the storage device 404, each functional unit which will be described later is realized.

Here, the program executed by the CPU 401 is provided to the external server 300 in a state of being stored in the computer-readable recording medium such as the magnetic recording medium (such as the magnetic tape or the magnetic disk), the optical recording medium (such as the optical disk), the magneto-optical recording medium, or the semiconductor memory. In addition, the program executed by the CPU 401 may be provided to the external server 300 using the communication unit such as the Internet.

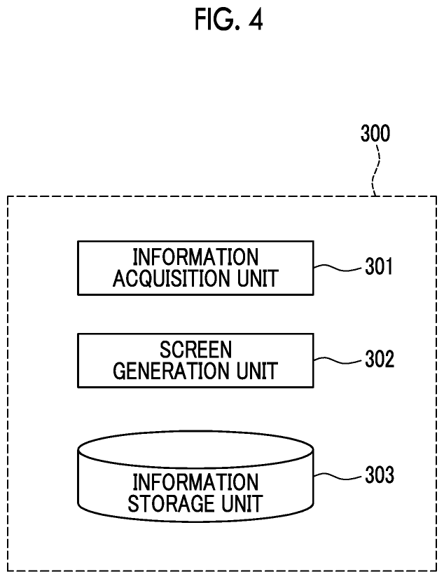

FIG. 4 is a block diagram illustrating functions of the external server 300.

The external server 300 includes an information acquisition unit 301, a screen generation unit 302, and an information storage unit 303.

Here, the information acquisition unit 301 and the screen generation unit 302 are realized in a case where the CPU 401 executes the program stored in the ROM 403 or the storage device 404. In addition, the information storage unit 303 is realized by the storage device 404.

Note that, in the exemplary embodiment, although a case, in which the functional units are provided in the external server 300 as an example of an information processing apparatus, is described, a plurality of information processing apparatuses may be prepared and the functional units may be separately provided to the plurality of information processing apparatuses.

In this case, the information processing system is configured by the plurality of information processing apparatuses, and a form is made in which the functional units are realized by the information processing system.

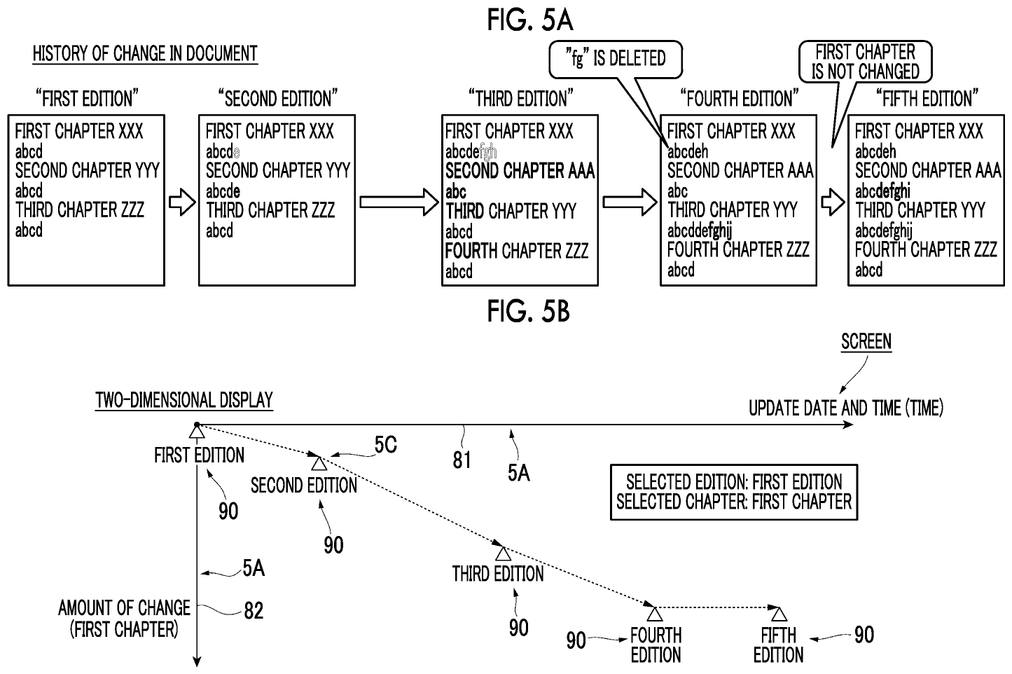

FIGS. 5A and 5B are diagrams illustrating processing executed by the external server 300.

In the external server 300 of the exemplary embodiment, in a case where a predetermined condition is satisfied as in a case where an instruction is given from a user, the information acquisition unit 301 as an example of an information acquisition section acquires, for each of a plurality of times of changes performed on a target document, information about a time, at which the change is performed, and the amount of change.

More specifically, in the exemplary embodiment, a document of each user is stored in the information storage unit 303 of the external server 300. In addition, a document of each edition edited by each user is stored in the information storage unit 303 of the external server 300. In other words, the document of each edition whose content is changed through editing is stored in the information storage unit 303 of the external server 300.

For example, in a case where a document is specified by the user, the information acquisition unit 301 acquires, for each of the plurality of times of changes performed on the specified document, information about the time, at which the change is performed, and the amount of change.

Further, in the exemplary embodiment, based on the information about the time, at which the change is performed and the amount of change, acquired by the information acquisition unit 301, the screen generation unit 302 as an example of a screen generation section generates a screen in which information about a change in the document is displayed.

More specifically, as illustrated in FIG. 5B, the screen generation unit 302 generates a screen in which information about each of the plurality of times of changes is displayed on a two-dimensional area using the time and the amount of change as axes.

More specifically, in the example illustrated in FIG. 5B, a horizontal axis is a time axis, a vertical axis is an axis indicating the amount of change, and the screen generation unit 302 generates a screen in which an image (hereinafter referred to as a “document image 90”) representing a document of each edition on the two-dimensional area represented by the two axes is displayed.

In addition, in the exemplary embodiment, an edition of the document is updated by the change performed on the document. The screen generation unit 302 generates a screen in which a document image 90 representing the document of each edition is displayed on the two-dimensional area.

In other words, the screen generation unit 302 generates a screen in which an image corresponding to a document on which a plurality of times of changes is performed is displayed on the two-dimensional area.

In addition, the screen generation unit 302 generates the screen in which the image corresponding to each of the plurality of times of changes is displayed on the two-dimensional area.

More specifically, the screen generation unit 302 generates a screen in which the image corresponding to the document, on which the plurality of times of changes is performed, is displayed at a location corresponding to the time, at which the change is performed, and the amount of change in the two-dimensional area.

In addition, the screen generation unit 302 generates a screen in which the image corresponding to each of the plurality of times of changes is displayed in the location corresponding to the time, at which the change is performed, and the amount of change in the two-dimensional area.

The screen, which is generated by the screen generation unit 302, for the document is transmitted to, for example, the terminal device 100 of the user who is an owner of the document, and the screen is displayed on the terminal device 100.

Note that, the screen generated by the screen generation unit 302 is the screen illustrated in FIG. 5B. The diagram illustrated in FIG. 5A is a diagram illustrating processing in the external server 300, and, basically, the diagram illustrated in FIG. 5A is not displayed on the terminal device 100.

However, the diagram illustrated in FIG. 5A may be included in the screen, and the diagram illustrated in FIG. 5A may be also displayed on the terminal device 100. In a case where the diagram illustrated in FIG. 5A is also displayed, it is possible for the user to recognize not only the amount of change performed on the document but also a changed location and changed content.

Note that, in the screen illustrated in FIG. 5B, a horizontal axis is the time axis and a vertical axis is an axis indicating the amount of change, but the horizontal axis may be the axis indicating the amount of change and the vertical axis may be the axis indicating the amount of change.

In addition, in the exemplary embodiment, as indicated by reference numeral 5A, an image representing the axes is displayed (an image corresponding to the horizontal axis and the vertical axis is displayed), but the image representing the axes is not compulsorily displayed.

Here, “the information about each of the plurality of times of changes is displayed on the two-dimensional area represented by the two axes” may indicate a state in which the information about each of the plurality of times of changes is displayed in a state in which existence of the two-dimensional area is known, and, for example, the image representing the axes may not be displayed, and the information about each of the plurality of times of changes may be displayed on a gird image configured by a plurality of vertical lines and a plurality of horizontal lines.

Further, in the exemplary embodiment, the user selects a reference edition by operating the own terminal device 100, and, in addition, selects a chapter in which the amount of change is recognized.

In addition, in the exemplary embodiment, the user selects the reference edition, and, in addition, selects a target in which the amount of change is recognized.

The example illustrated in FIG. 5B illustrates a case where a first edition is selected by the user as the reference edition. In addition, the example illustrated in FIG. 5B illustrates a case where a first chapter in the document is selected as the target in which the amount of change is recognized.

In this case, the information acquisition unit 301 recognizes the amount of change using the first edition as the reference. In addition, in this case, the information acquisition unit 301 recognizes the amount of change for the first chapter in the document.

In addition, in the exemplary embodiment, the screen generation unit 302 displays an image indicating the selected edition.

In the exemplary embodiment, the screen generation unit 302 displays an image indicating the horizontal axis (hereinafter, referred to as a “horizontal axis image 81”) and an image indicating the vertical axis (hereinafter, referred to as a “vertical axis image 82”) as the image indicating the selected edition.

More specifically, the screen generation unit 302 displays the horizontal axis image 81 and the vertical axis image 82 such that each of the horizontal axis image 81 and the vertical axis image 82 passes through the first edition which is the edition selected by the user, and clarifies that the selected edition is the first edition.

Note that, the horizontal axis image 81 also has a role as an image indicating a reference for the amount of change, and the document image 90 of each edition moves in a direction which is separated from the horizontal axis image 81, that is, to a lower side as the document is changed.

In addition, in the exemplary embodiment, the vertical axis image 82 has a role as an image indicating a reference for the time, at which the change is performed, and the document image 90 of a document, in which the change is performed at a later timing, is displayed in a direction which is separated from the vertical axis image 82, that is, to a right side.

Note that, in the exemplary embodiment, although a case where both the horizontal axis image 81 and the vertical axis image 82 are displayed is described as an example, only one of the horizontal axis image 81 and the vertical axis image 82 may be displayed.

In addition, in the exemplary embodiment, a fact that the edition selected by the user is the first edition is shown by causing the horizontal axis image 81 and the vertical axis image 82 to pass through the document image 90 of the first edition.

However, the exemplary embodiment is not limited thereto, and any of edition corresponding to an edition selected by the user may be clarified in such a way that words “selection edition” and “reference edition” is displayed in association with the document image 90 of the first edition or an image, such as a mark, indicating a selected edition is displayed in association with the document image 90 of the first edition.

In the example illustrated in FIG. 5B, as described above, the first chapter is selected as the target in which the amount of change is recognized.

Further, in the example, as illustrated in FIG. 5A, in a case where the document is changed from the first edition to the second edition, a text “e” is added to the first chapter. In this case, the information acquisition unit 301 acquires “+1” as the amount of change in the document.

Further, in the exemplary embodiment, in this case, as indicated by reference numeral 5C, the screen generation unit 302 causes the document image 90 indicating the second edition to be located on a lower side than the document image 90 indicating the first edition.

More specifically, the screen generation unit 302 causes the document image 90 indicating the second edition to be located on the lower side than the document image 90 indicating the first edition by an amount corresponding to one text.

In addition, in the example, in a case where the document is changed from the second edition to the third edition, texts “fgh” are added to the first chapter. In this case, the information acquisition unit 301 acquires “+3” as the amount of change in the document.

Further, in this case, the screen generation unit 302 causes the document image 90 indicating the third edition to be located on a lower side than the document image 90 indicating the second edition by an amount corresponding to three texts.

In addition, in the example, in a case where the document is changed from the third edition to the fourth edition, the texts “fg” are deleted from the first chapter. In this case, the information acquisition unit 301 acquires “+2” as the amount of change of the document.

Further, in this case, the screen generation unit 302 causes the document image 90 indicating the fourth edition to be located on a lower side than the document image 90 indicating the third edition by an amount corresponding to two texts.

Here, in the exemplary embodiment, the information acquisition unit 301 acquires the information about the time, at which the change is performed, and the amount of change for the first chapter corresponding to a selection part, which is selected by the user, of the document.

Further, in the exemplary embodiment, the screen generation unit 302 generates a screen in which information about each change in the selection part is displayed on a two-dimensional area.

Note that, in the example, in a case where the document is changed from the second edition to the third edition, the second chapter is newly added, and, accordingly, the old second chapter is moved down to the new third chapter.

Here, the chapters are not the chapters selected by the user, and thus the screen generation unit 302 does not reflect the change in the chapters on a screen to be generated.

In addition, in the example, a change in which texts “fghij” are added to the third chapter is performed in a case where the document is changed from the third edition to the fourth edition, and a change in which texts “defghi” are added to the second chapter is performed in a case where the document is changed from the fourth edition to the fifth edition. Here, for the same reason, the changes are not reflected on the screen to be generated.

Here, as described above, the information acquisition unit 301 acquires information about the amount of change based on the amount of change in the number of texts included in the document.

More specifically, the information acquisition unit 301 acquires the information about the amount of change based on the number of texts deleted from the document and the number of texts added to the document.

More specifically, the information acquisition unit 301 acquires a number, acquired by adding the number of texts deleted from the document and the number of texts added to the document, as the information about the amount of change.

Note that, the number is only an example, and, in addition thereto, the information acquisition unit 301 may acquire the information about the amount of change based on, for example, only one of the number of texts deleted from the document and the number of texts added to the document.

In addition, in the exemplary embodiment, as above, the number of texts is counted and the information about the amount of change is acquired based on the number of texts. However, the exemplary embodiment is not limited thereto, and, for example, the information acquisition unit 301 may acquire the information about the amount of change based on a change in the amount of information of information included in the document.

More specifically, the information acquisition unit 301, for example, may recognize a file size of the document for each document of each edition and may acquire the information about the amount of change based on a change in the file size.

In addition, in the above description, although the information about the amount of change is acquired while targeting the “chapter” selected by the user, the exemplary embodiment is not limited to the “chapter”, and the information about the amount of change may be acquired while targeting, for example, a “paragraph”.

In addition, the exemplary embodiment is not limited to a part of the document, and the information about the amount of change may be acquired while targeting a whole document. In this case, the user is not needed to select the chapter, and the information about the amount of change is acquired while targeting the whole document.

In addition, in the above description, although a case where the screen is generated for the first chapter is described, the information about the amount of change and the time, at which the change is performed, may be acquired for each chapter such that the screen generation unit 302 may generate the screen for each chapter.

More specifically, in a case where the processing is performed, the information acquisition unit 301 acquires, for each chapter, the information about the time, at which the change is performed, and the amount of change.

In addition, it is possible to grasp each chapter of the document as a unit configuring the document, and, in this case, the information acquisition unit 301 acquires, for each unit of a plurality of units included in the document, the information about the time, at which the change is performed, and the amount of change.

Further, in this case, the screen generation unit 302 generates, for each chapter, a screen in which the information about the time, at which the change is performed, and the amount of change is displayed based on the information about the time, at which the change is performed, and the amount of change, the information being obtained for each chapter.

In addition, in this case, the screen generation unit 302 generates, for each unit, a screen in which the information about the time, at which the change is performed, and the amount of change is displayed based on the information about the time, at which the change is performed, and the amount of change, the information being obtained for each unit configuring the document.

Note that, in FIG. 5B, in a case where the document images 90 of the respective editions are displayed to be arranged in a time axis direction, the document images 90 of the respective editions are disposed such that elapsed time from a change to a subsequent change is reflected on a disposition interval of the document images 90.

In this case, in a case where the elapsed time is short, the adjacent document images 90 approach each other, and, in contrast, in a case where the elapsed time is long, the adjacent document images 90 are separated.

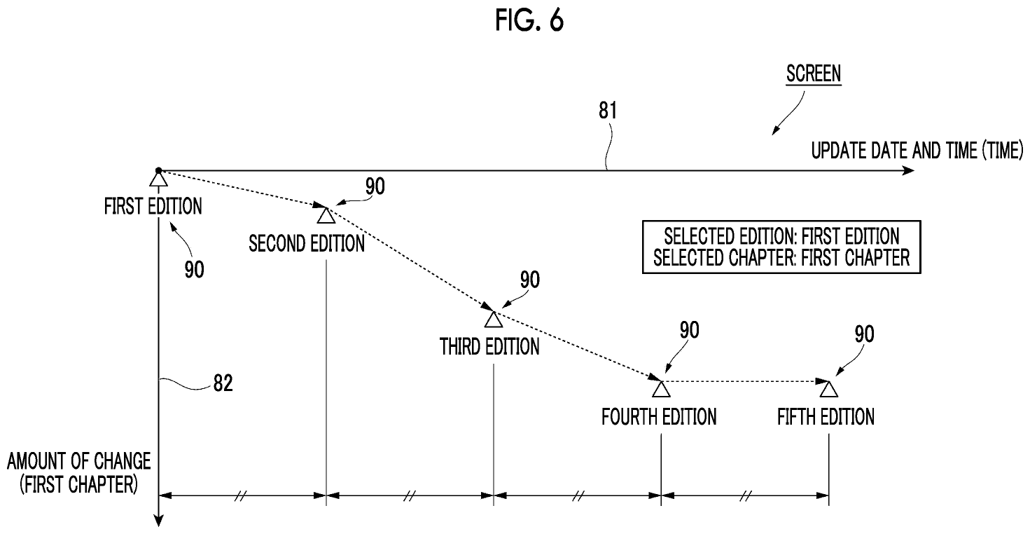

Meanwhile, the exemplary embodiment is not limited to the display form, and the screen generation unit 302 may arrange the document images 90 of the respective editions in an order of the time, at which the change is performed, to be arranged at equal intervals in the time axis direction, as illustrated in FIG. 6 (a diagram illustrating another example of the screen generated by the screen generation unit 302).

In this case, compared to a case where the document images 90 indicating the respective editions are not arranged at equal intervals in the time axis direction, it becomes easy to recognize whether the amount of one change performed on the document is large or small.

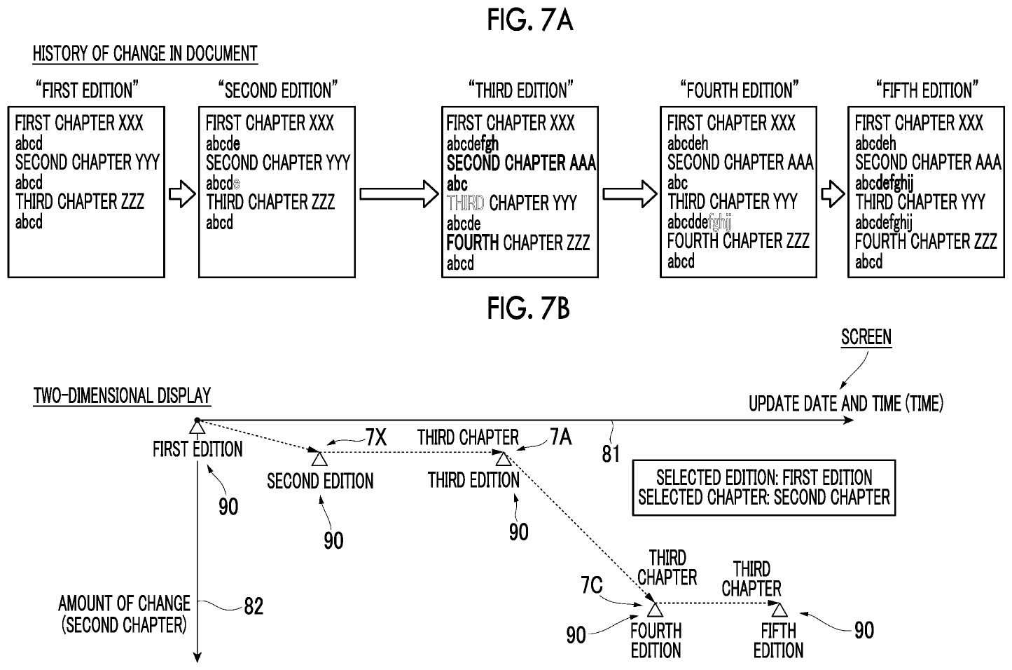

FIGS. 7A and 7B are diagrams illustrating another screen generated by the screen generation unit 302.

FIGS. 7A and 7B illustrate a case where the first edition is selected as the reference edition and, in addition, the second chapter is selected as the target in which the amount of change is recognized.

In the example, in a case where the first edition is changed to the second edition, the text “e” is added to the second chapter, and, accordingly, as indicated by reference numeral 7X, the document image 90 indicating the second edition is moved downward by an amount corresponding to one text.

Further, in the example, in a case where the second edition is changed to the third edition, a new document is added subsequently to the first chapter, and the added document becomes a new second chapter.

As a result, the document which is the second chapter is moved down to become a new third chapter.

In addition, in the example, in a case where the second edition is changed to the third edition, the location of the document which is the second chapter so far is changed and moved downward, and, further, a chapter number at a beginning is changed from “2” to “3”.

In this case, the screen generation unit 302 disposes information indicating that the location is changed on the screen. In addition, the screen generation unit 302 displays information indicating that the chapter number at the beginning is changed on the screen.

More specifically, the screen generation unit 302 disposes texts “third chapter”, as indicated by reference numeral 7A. In addition, the screen generation unit 302 puts information indicating that the old “second chapter” which is the target selected by the user becomes the “third chapter” on the screen.

In addition, the example illustrates a case where a new chapter is added and content of the second chapter, which is the chapter selected by the user, becomes content of the third chapter. Further, in this case, hereinafter, in the exemplary embodiment, a target, in which the amount of change and the time of change are recognized, is set to the third chapter.

Further, in this case, the screen generation unit 302 causes the document images 90 subsequent to the third edition to display the words “third chapter”, and clarifies that a target, in which the time of change and the amount of change are recognized, is switched to the “third chapter”.

Here, basic processing of the information acquisition unit 301 of the exemplary embodiment will be described.

In a case where the document is acquired, the information acquisition unit 301 performs division on the document according to a predetermined condition, and holds the document for each predetermined unit.

More specifically, for example, the information acquisition unit 301 holds the document for each chapter by recognizing the texts “chapter” or holds the document for each paragraph by recognizing a blank space at a beginning of a sentence. In this case, the information acquisition unit 301 holds a plurality of fragmented documents.

Further, for example, in a case where a chapter is selected by the user, the information acquisition unit 301 focuses on the chapter selected by the user and held by the information acquisition unit 301, and recognizes whether or not the focused chapter is changed.

Further, in a case where a text is deleted or added from or to the focused chapter, the information acquisition unit 301 recognizes the amount of change in the focused chapter, as described above.

In addition, in a case where the chapter number at the beginning is changed in the focused chapter as described above, the information acquisition unit 301 outputs information indicating that the chapter number is changed.

Further, in the exemplary embodiment, as a result, as described above, the screen generation unit 302 displays information indicating that the chapter number at the beginning, such as the words “third chapter”, is changed on the screen.

Subsequent to the fourth edition, the information acquisition unit 301 focuses on the “third chapter”, and acquires the information about the time, at which the change is performed, and the amount of change for the “third chapter”.

Further, in the example, in a case where the third edition is changed to the fourth edition, “fghij” is added to the “third chapter”.

Therefore, in the example, the screen generation unit 302 causes, as indicated by reference numeral 7C, the document image 90 indicating the fourth edition to move downward.

Note that, in a case where the document image 90 indicating the fourth edition is displayed, the screen generation unit 302 causes the texts “third chapter” to be displayed in association with the document image 90 indicating the fourth edition.

Similarly, even in a case where a document image 90 indicating the fifth edition is displayed, the screen generation unit 302 causes the texts “third chapter” to be displayed in association with the document image 90 indicating the fifth edition.

Here, in the example, the information acquisition unit 301 acquires the information about the time, at which the change is performed, and the amount of change for the second chapter corresponding to the selection part, which is selected by the user, in the document.

Further, in the exemplary embodiment, the screen generation unit 302 generates a screen in which information about each change in the selection part is displayed on a two-dimensional area.

Further, in the exemplary embodiment, the screen generation unit 302 generates the screen in which, in a case where a location of the selection part is changed in the document, information indicating that the location is changed is further displayed.

More specifically, for example, as described above, in a case where a location of the second chapter, which is the selection part selected by the user, is changed, the screen generation unit 302 generates a screen in which the information indicating that the location is changed is further displayed. More specifically, as described above, the screen generation unit 302 generates a screen in which the words “third chapter” is further displayed.

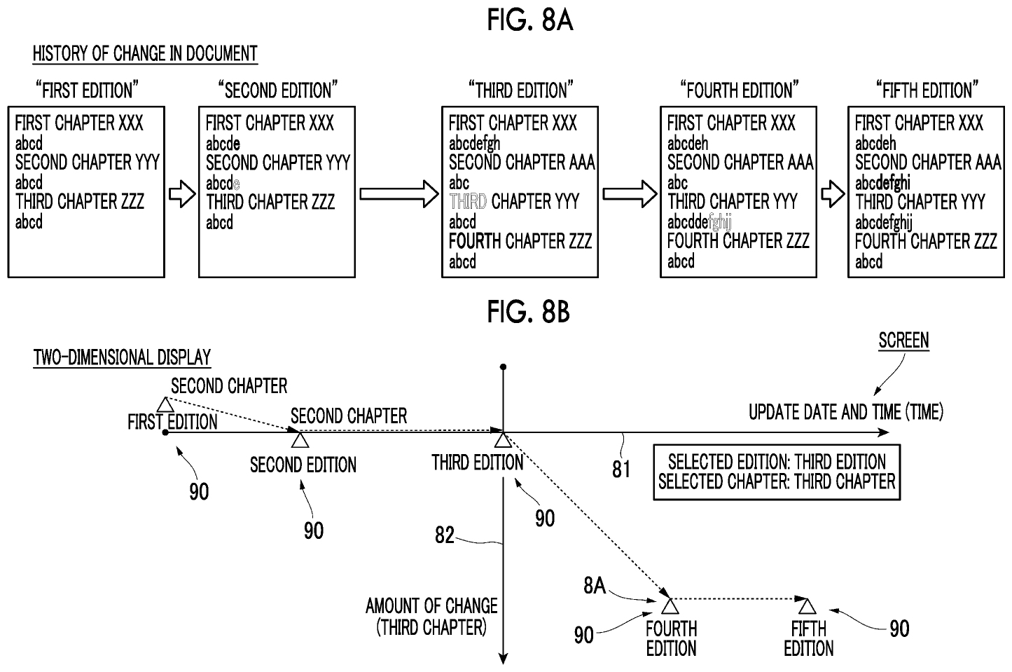

FIGS. 8A and 8B are diagrams illustrating another screen generated by the screen generation unit 302.

Examples illustrated in FIGS. 8A and 8B illustrate a case where the third edition is selected by the user as the reference edition and, in addition, the third chapter is selected as the target in which the amount of change is recognized.

In this case, as illustrated in FIG. 8B, the screen generation unit 302 disposes the horizontal axis image 81 and the vertical axis image 82 such that the horizontal axis image 81 and the vertical axis image 82 pass through the document image 90 of the selected third edition.

In the example, in a case where the document is changed from the third edition to the fourth edition, the texts “fghij” are added to the third chapter, and, accordingly, as indicated by reference numeral 8A, the document image 90 indicating the fourth edition is moved downward by an amount corresponding to five texts.

In addition, in the example, in a case where the document is changed from the fourth edition to the fifth edition, the third chapter is not changed, and the document image 90 indicating the fifth edition does not move.

In addition, although the texts “defghi” are added to the second chapter in a case where the document is changed from the fourth edition to the fifth edition, the second chapter is not the chapter selected by the user, and thus the document image 90 indicating the fifth edition is not moved.

Furthermore, in the example, the third chapter selected by the user is the second chapter in the edition before the second edition, and, in this case, the screen generation unit 302 displays words “second chapter” in association with each of the document images 90 of the first and second editions.

More specifically, in the example, in a case where the document is changed from the second edition to the third edition, a new second chapter is added, and thus the third chapter, which is the chapter selected by the user, becomes the second chapter in the second edition.

In this case, the screen generation unit 302 displays the words “second chapter” in association with each of the document images 90 of the first and second editions.

In addition, in the example, the chapter is added, and the content of the second chapter is changed to the content of the third chapter from the middle, but the own content of the second chapter and the own content of the third chapter are not changed.

On the other hand, the target, in which the amount of change is recognized, is changed to the old second chapter from the middle, and thus the screen generation unit 302 displays the words “second chapter” and clarifies that the amount of change for the second chapter is recognized before the chapter is added.

Further, in the example, in a case where the document is changed from the first edition to the second edition, “e” is added to the “second chapter”, and, in the example, the document image 90 of the second edition is moved downward by an amount corresponding to one text, compared to the document image 90 of the first edition.

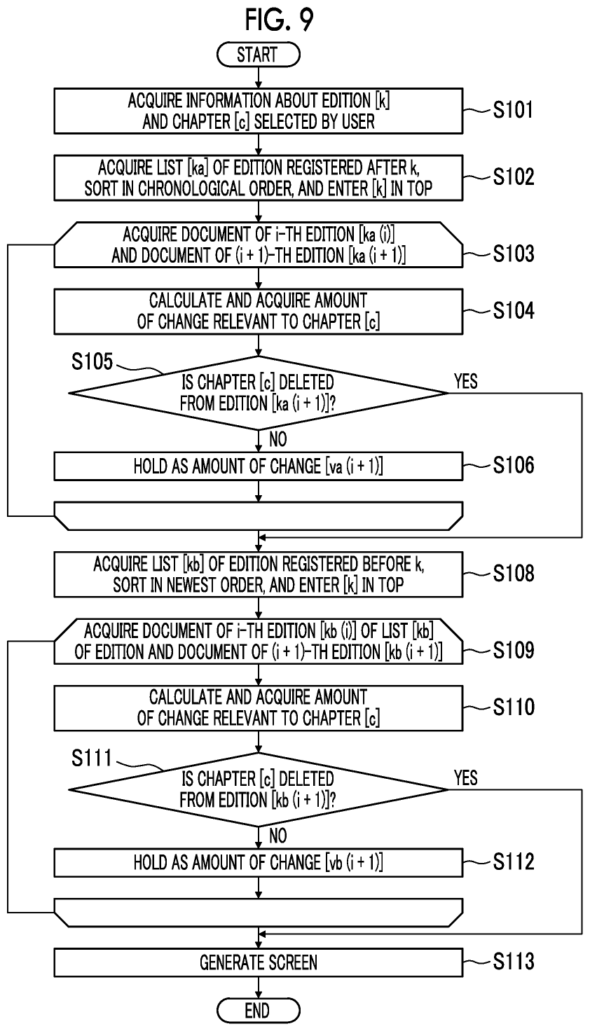

FIG. 9 is a flowchart illustrating a flow of the processing performed by the external server 300.

In the exemplary embodiment, first, the information acquisition unit 301 acquires information about an edition [k] selected by the user and a chapter [c] selected by the user (step S101).

Subsequently, the information acquisition unit 301 acquires a list [ka] of editions registered after the edition [k] selected by the user, sorts the editions in the list [ka] in chronological order, and sets the edition [k] selected by the user to a top of the list (step S102).

Subsequently, the information acquisition unit 301 acquires a document of an i-th edition [ka(i)] and a document of an (i+1)-th edition [ka (i+1)] in the edition list [ka] (step S103).

Subsequently, the information acquisition unit 301 calculates and acquires the amount of change in a change generated between the document of the edition [ka(i)] and the document of the edition [ka(i+1)], that is, the amount of change in a change generated for the chapter [c] selected by the user (step S104).

Subsequently, in step S105, the information acquisition unit 301 determines whether the chapter [c] is deleted in the edition [ka(i+1)], and, in a case where it is determined that the chapter [c] is deleted, the process proceeds to processing subsequent to step S108.

In addition, the information acquisition unit 301 determines whether or not a chapter [c] having the same content as the chapter [c] selected by the user exists in the edition [ka(i+1)] instead of a chapter [c] that exists formally, and, in a case where it is determined that the chapter [c] having the same content as the chapter [c] selected by the user does not exist, the process proceeds to processing subsequent to step S108.

Here, it is determined whether or not the chapter [c] having the same content as the chapter [c] selected by the user exists based on the number of texts such that, for example, the number of matching texts is recognized between, for example, the chapter [c] selected by the user and each of a plurality of other chapters.

More specifically, in a case where the number of matching texts exceeds a predetermined threshold, it is determined that the chapter [c] having the same content as the chapter [c] selected by the user exists, and, in a case where the number of matching texts is equal to or smaller than the threshold, it is determined that the chapter [c] having the same content as the chapter [c] selected by the user does not exist.

Note that, the determination of whether or not the chapter [c] having the same content as the chapter [c] selected by the user exists is not limited thereto, and may be performed using another known method for distinguishing a similarity between documents.

On the other hand, in a case where it is determined that the chapter [c] is not deleted in the edition [ka(i+1)] (in a case where it is determined that the chapter [c] having the same content as the chapter [c] selected by the user exists) in step S105, the information acquisition unit 301 holds the amount of change calculated in step S104 as the amount of change [va(i+1)] (step S106).

In a case where the processing in step S106 is performed, 1 is added to i, and the processing subsequent to step S103 is performed again.

Further, until it is determined that the chapter [c] is deleted in step S105 or until the amount of change [va(i+1)] for a final edition is acquired in step S106, the processing in step S103 to step S106 are repeated.

Subsequently, in the exemplary embodiment, the processing subsequent to step S108 is executed.

In the processing in step S108, the information acquisition unit 301 acquires a list [kb] of editions registered before the edition [k], sorts the editions in the list [kb] in a new order, and sets the edition [k] selected by the user to the top of the list.

Subsequently, the information acquisition unit 301 acquires a document of an i-th edition [kb(i)] and a document of an (i+1)-th edition [kb(i+1)] in the edition list [kb] (step S109).

Subsequently, the information acquisition unit 301 calculates and acquires the amount of change in a change generated between a document of the edition [kb(i)] and a document of the edition [kb (i+1)], that is, the amount of change in a change generated in the chapter [c] (step S110).

Subsequently, in step S111, it is determined whether or not the chapter [c] is deleted in the edition [kb(i+1)], and, in a case where it is determined that the chapter [c] is deleted, the process proceeds to processing subsequent to step S113.

On the other hand, in a case where it is determined that the chapter [c] is not deleted in step S111, the information acquisition unit 301 holds the amount of change calculated in step S110 as the amount of change [vb(i+1)] (step S112).

In a case where the processing in step S112 is performed, 1 is added to i, and the processing subsequent to step S109 is performed again.

Further, in step S111, until it is determined that the chapter [c] is deleted or until the amount of change [vb(i+1)] for a final edition of the list [kb] is acquired, processing in steps S109 to S112 are repeated.

Thereafter, in the exemplary embodiment, the screen generation unit 302 generates the above-described screen (step S113).

More specifically, the screen generation unit 302 acquires information about a time at which each edition is changed, and further acquires information about the amount of changes [va] and [vb] acquired by the information acquisition unit 301.

Further, the screen generation unit 302 generates the above-described screen based on the pieces of acquired information.

Note that, for the information about the time at which each edition is changed, the screen generation unit 302 reads and acquires the information about the time from the information storage unit 303.

More specifically, the information storage unit 303 of the exemplary embodiment stores the document of each edition, and stores information about the time, at which the change is performed, in association with each document of each edition.

The screen generation unit 302 reads the information about the time from the information storage unit 303 and acquires the information about the time at which each edition is changed.

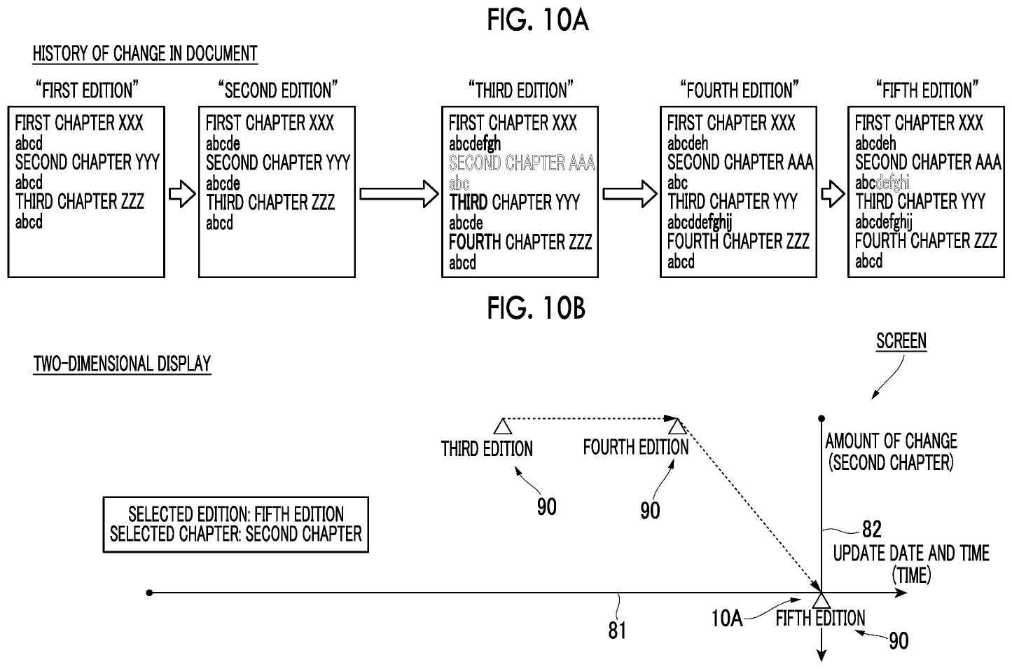

FIGS. 10A and 10B are diagrams illustrating an example of another screen generated by the screen generation unit 302.

The example illustrated in FIG. 10B illustrates a case where the fifth edition is selected as the reference edition, and, in addition, the second chapter is selected as the target in which the amount of change is recognized.

In this case, the horizontal axis image 81 and the vertical axis image 82 are displayed to pass through the document image 90 of the fifth edition.

In the example, in a case where the fourth edition is changed to the fifth edition, six texts of texts “defghi” are added to the second chapter, and, accordingly, as indicated by reference numeral 10A, the document image 90 indicating the fifth edition is moved downward by an amount corresponding to the six texts, compared to the document image 90 indicating the fourth edition.

Further, in the example, the second chapter selected by the user is added in the third edition, and the second chapter does not exist in the first and second editions.

Therefore, in the example, the document image 90 of the first edition and the document image 90 of the second edition are not displayed. In addition, before the second edition, a chapter having the same content as the second chapter selected by the user does not exist, a target in which the amount of change is recognized does not exist, and thus the document image 90 before the second edition is not displayed.

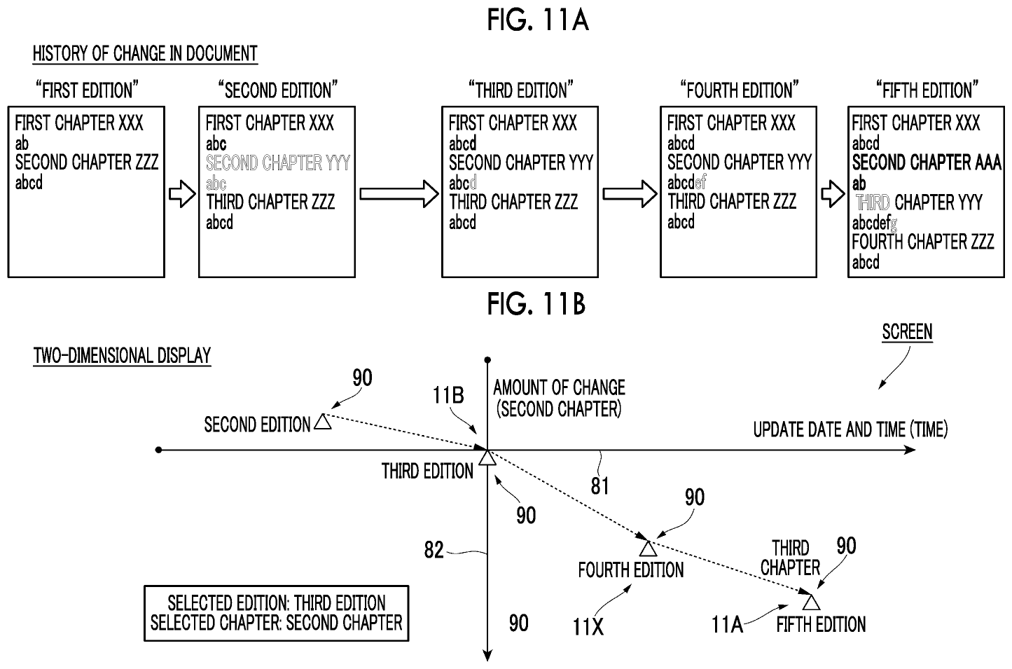

FIGS. 11A and 11B are diagrams illustrating an example of another screen generated by the screen generation unit 302.

The example illustrated in FIG. 11B illustrates a case where the third edition is selected as the reference edition, and the second chapter is selected as the target in which the amount of change is recognized.

In this case, the horizontal axis image 81 and the vertical axis image 82 are displayed to pass through the document image 90 of the third edition.

In the example, in a case where the third edition is changed to the fourth edition, texts “ef” is added to the second chapter, and, accordingly, as indicated by reference numeral 11X, the document image 90 indicating the fourth edition is moved downward by an amount corresponding to two texts, compared to the document image 90 indicating the third edition.

Further, in the example, in a case where the fourth edition is changed to the fifth edition, the second chapter becomes the third chapter, and a text “g” is added to the third chapter.

For this reason, in the example, as indicated by reference numeral 11P, the texts “third chapter” are displayed in association with the document image 90 of the fifth edition, and, further, the document image 90 indicating the fifth edition is moved downward by an amount corresponding to one text.

In addition, in the example, in a case where the second edition is changed to the third edition, one text of the text “d” is added, and, accordingly, as indicated by reference numeral 11B, the document image 90 indicating the third edition is moved downward by an amount corresponding to one text.

Further, in the example, the second chapter is added in the second edition. Therefore, in the example, the document image 90 of the first edition is not displayed.

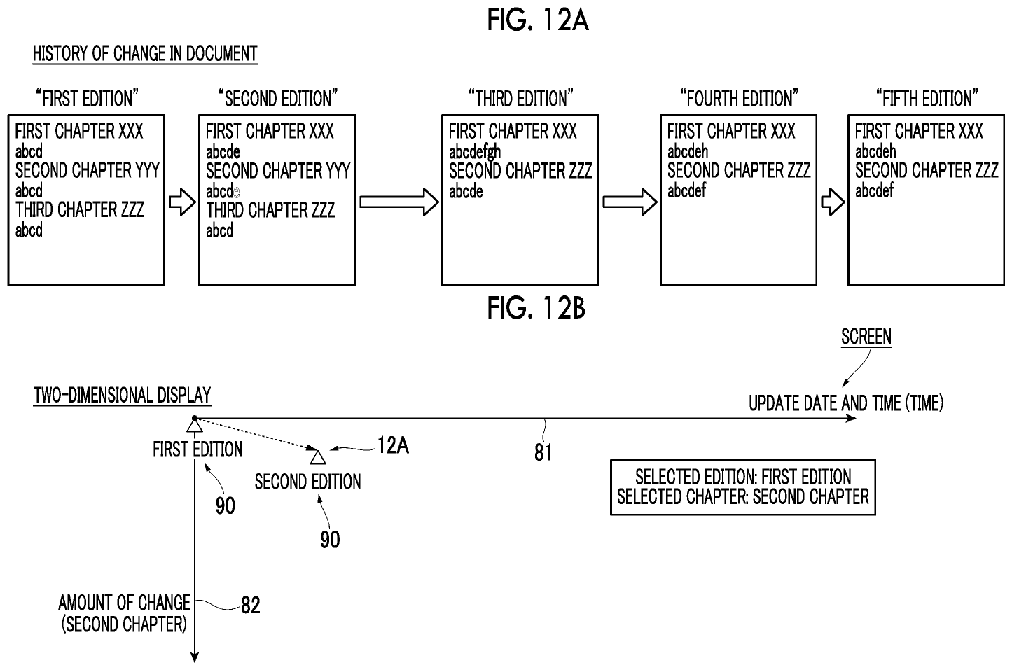

FIGS. 12A and 12B are diagrams illustrating an example of another screen generated by the screen generation unit 302.

The example illustrated in FIG. 12B illustrates a case where the first edition is selected as the reference edition, and the second chapter is selected as the target in which the amount of change is recognized.

In this case, the horizontal axis image 81 and the vertical axis image 82 are displayed to pass through the document image 90 of the first edition.

Further, in the example, in a case where the first edition is changed to the second edition, a text “e” is added to the second chapter, and, accordingly, as indicated by reference numeral 12A, the document image 90 indicating the second edition is moved downward by an amount corresponding to one text.

Further, in the example, in a case where the second edition is changed to the third edition, the second chapter is deleted. Therefore, in the example, the document images 90 subsequent to the third edition are not displayed.

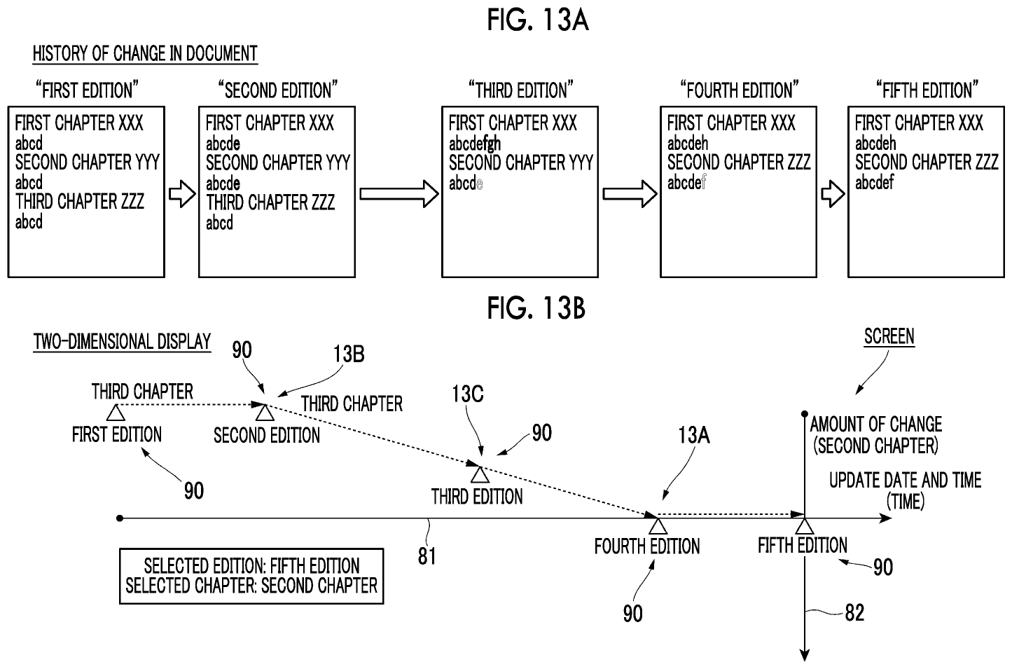

FIGS. 13A and 13B are diagrams illustrating an example of another screen generated by the screen generation unit 302.

The example illustrated in FIG. 13B illustrates a case where the fifth edition is selected as the reference edition, and the second chapter is selected as the target in which the amount of change is recognized.

In this case, the horizontal axis image 81 and the vertical axis image 82 are displayed to pass through the document image 90 of the fifth edition.

In the example, in a case where the fourth edition is changed to the fifth edition, the second chapter is not changed, and a location of the document image 90 of the fourth edition is the same as a location of the document image 90 of the fifth edition.

In addition, the location of the document image 90 of the fourth edition is the same as the location of the document image 90 of the fifth edition in a vertical axis direction indicating the amount of change.

In addition, in the example, in a case where the third edition is changed to the fourth edition, a text “f” is added to the second chapter, and, accordingly, as indicated by reference numeral 13A, the document image 90 indicating the fourth edition is moved downward by an amount corresponding to one text.

Further, in the example, in a case where the second edition is changed to the third edition, the old second chapter is deleted, the old third chapter becomes the second chapter selected by the user, and, further the text “e” is added to the second chapter.

Therefore, in the example, as indicated by reference numeral 13B, the texts “third chapter” are displayed in association with the document image 90 of the second edition. Further, in the example, as indicated by reference numeral 13C, the document image 90 indicating the third edition is moved downward by an amount corresponding to one text as compared with the document image 90 indicating the second edition.

Further, in the example, in a case where the first edition is changed to the second edition, the third chapter is not changed, and the location of the document image 90 of the first edition and the location of the document image 90 of the second edition are the same. In addition, the location of the document image 90 of the first edition and the location of the document image 90 of the second edition are the same in the vertical axis direction indicating the amount of change.

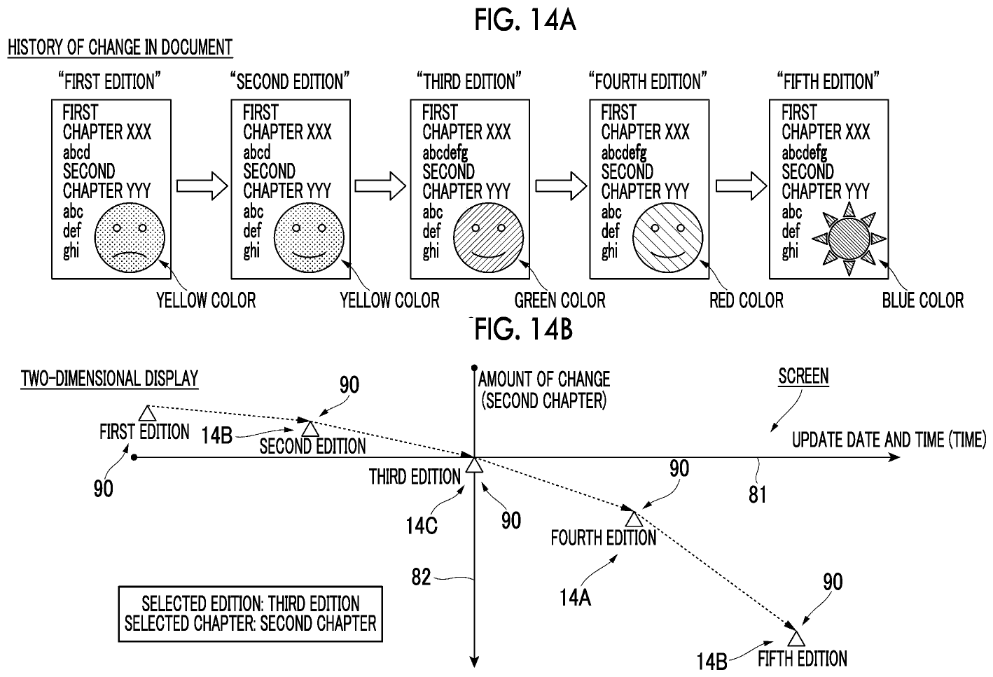

FIGS. 14A and 14B are diagrams illustrating an example of another screen generated by the screen generation unit 302.

In the above, although a screen generated in a case where the text is deleted or the text is added is described, the case is not limited to the text, and there is a case where a figure included in a document is changed, as illustrated in FIG. 14A.

Also in this case, in the exemplary embodiment, similarly to the above, the information acquisition unit 301 recognizes the time, at which the change is performed, and the amount of change, and, further, the screen generation unit 302 generates a screen, on which the document image 90 representing a document of each edition is displayed, based on the information.

More specifically, the example illustrated in FIG. 14B illustrates a case where the third edition is selected as the reference edition, and the second chapter is selected as the target in which the amount of change is recognized. Further, the example illustrated in FIGS. 14A and 14B illustrates a case where a figure included in the second chapter is changed.

In the example, in a case where the third edition is changed to the fourth edition, the figure included in the second chapter is changed, and, accordingly, as indicated by reference numeral 14A, the document image 90 indicating the fourth edition is moved down.

In addition, in the example, in a case where the third edition is changed to the fourth edition, a color of the figure included in the second chapter is changed from a color of green to a color of red, and, accordingly, as indicated by reference numeral 14A, the document image 90 indicating the fourth edition is moved downward.

In addition, in the example, in a case where the third edition is changed to the fourth edition, the color is changed to greatly differentiate impression of the figure, and, accordingly, as indicated by reference numeral 14A, the document image 90 indicating the fourth edition is largely moved downward.

Further, in the example, in a case where the fourth edition is changed to the fifth edition, a shape of the figure and the color of the figure included in the second chapter are changed, and, accordingly, as indicated by reference numeral 14B, the document image 90 indicating the fifth edition is largely moved downward.

More specifically, in the example, the figure that has the color of red and a circular shape in the fourth edition is changed to a figure that has a color of blue and a sun shape in the fifth edition.

Therefore, in the example, as indicated by reference numeral 14B, the document image 90 indicating the fifth edition is largely moved downward.

Here, in the fifth edition, both the shape of the figure and the color of the figure are changed. In contrast, in the fourth edition, only the color of the figure is changed.

Therefore, in the example, the amount of downward movement of the document image 90 indicating the fourth edition with respect to the document image 90 indicating the third edition is greater than the amount of downward movement of the document image 90 indicating the fifth edition with respect to the document image 90 indicating the fourth edition.

Further, in the example, in a case where the second edition is changed to the third edition, the figure included in the second chapter is changed, and, accordingly, as indicated by reference numeral 14C, the document image 90 indicating the third edition is moved downward with respect to the document image 90 indicating the second edition.

More specifically, in the example, in a case the second edition is changed to the third edition, the color of the figure included in the second chapter is changed from a color of yellow green to the color of green, and, accordingly, as indicated by reference numeral 14C, the document image 90 indicating the third edition is moved downward.

In addition, in the exemplary embodiment, in a case where the second edition is changed to the third edition, only the color of the figure included in the second chapter is changed, and, accordingly, the document image 90 indicating the third edition is moved downward.

In addition, in the example, the color of the figure in the second edition and the color of the figure in the third edition are similar colors, and the amount of change in the color of the figure is small. Therefore, in the example, the amount of downward movement of the document image 90 indicating the third edition is small.

Further, in the example, in a case where the first edition is changed to the second edition, the figure included in the second chapter is changed, and, accordingly, as indicated by reference numeral 14B, the document image 90 indicating the second edition is moved downward.

More specifically, in a case where the first edition is changed to the second edition, a shape of a part of the figure included in the second chapter is changed, and, accordingly, as indicated by reference numeral 14B, the document image 90 indicating the second edition is moved downward.

More specifically, in a case where the first edition is changed to the second edition, a shape of a mouth part of a figure representing a face of a person, included in the second chapter, is changed, and, accordingly, document image 90 indicating the second edition is moved downward.

The amount of change in a change performed in a case where the document becomes the second edition is small, and the amount of downward movement of the document image 90 of the second edition is small.

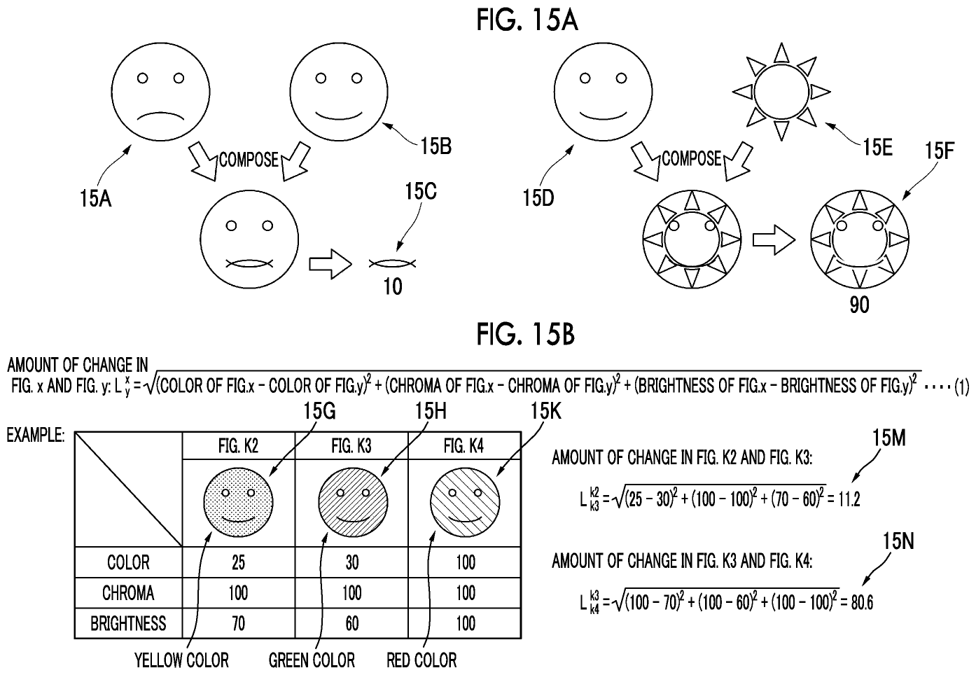

FIGS. 15A and 15B are diagrams illustrating a method for calculating the amount of change in a case where the figure is changed.

The information acquisition unit 301 of the exemplary embodiment acquires individually the amount of change for each of the shape of the figure and the color of the figure, adds the individually obtained amount of the change, and acquire the final amount of the change.

For the amount of change in a change of the shape, the information acquisition unit 301 extracts pixels whose values do not match before and after the change, and acquires the sum of the number of pixels whose values do not match as the amount of change.

For example, in a case where an image indicated by reference numeral 15A in FIG. 15A is changed to an image indicated by reference numeral 15B, each pixel indicated by reference numeral 15C is the pixel whose value does not match.

In the example, the number of pixels whose values do not match is 10, and the information acquisition unit 301 acquires 10 as the amount of change.

Further, for example, in a case where an image indicated by reference numeral 15D in FIG. 15A is changed to an image indicated by reference numeral 15E, each pixel indicated by reference numeral 15F is the pixel whose value does not match.

In the example, the number of pixels whose values do not match is 90, and, in this case, the information acquisition unit 301 acquires 90 as the amount of change.

In addition, for the amount of change in a color, the information acquisition unit 301 recognizes the Euclidean distance based on hue, saturation, and brightness of a figure before change is performed, and hue, saturation, and brightness of the figure after the change is performed, and acquires the recognized Euclidean distance as the amount of change.

More specifically, the information acquisition unit 301 recognizes the Euclidean distance by using expression (1) illustrated in FIG. 15B, and acquires the amount of change in the color.

Here, for example, in a case where a yellow green figure indicated by reference numeral 15G is changed to a green figure indicated by reference numeral 15H, the information acquisition unit 301 calculates 11.2 as indicated by reference numeral 15M, and acquires 11.2 as the amount of change.

In addition, in a case where the green figure indicated by reference numeral 15H is changed to a red figure indicated by reference numeral 15K, as indicated by reference numeral 15N, the information acquisition unit 301 calculates 80.6, and acquires 80.6 as the amount of change.

The amount of change in the shape of the figure or the color of the figure may be acquired using another known method.

For example, a distribution (histogram) of an appearance frequency of a color in the figure (for example, see JP5396960B) is compared, thus the amount of change may be acquired. In addition, for example, a feature point of an image is extracted, thus the amount of change may be acquired according to a distance thereof (for example, see JP5814714B).

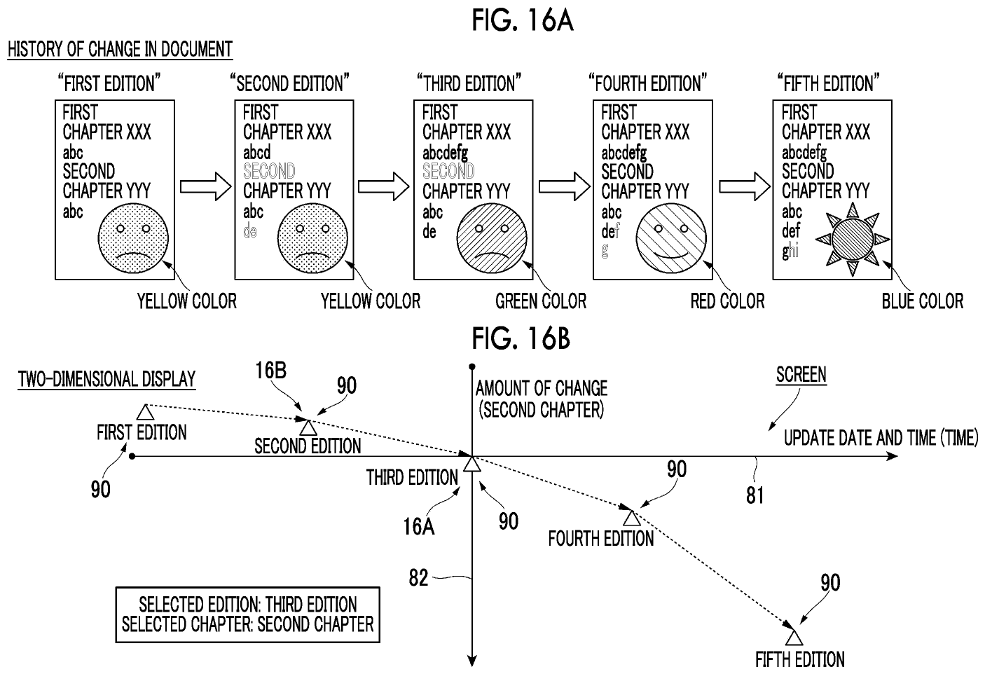

FIGS. 16A and 16B are diagrams illustrating another screen generated by the screen generation unit 302.

An example illustrated in FIG. 16B illustrates a case where the third edition is selected as the reference edition, and the second chapter is selected as the target in which the amount of change is recognized.

In the example, similarly to the above, in a case where the third edition is changed to the fourth edition, a figure included in the second chapter is changed. In addition, in the example, in a case where the third edition is changed to the fourth edition, addition of the texts “fg” is performed, and a change in the texts is also performed.

In this case, the screen generation unit 302 determines the disposition location of the document image 90 indicating the fourth edition based on the amount of change of each of the figure and the text, and causes the document image 90 indicating the fourth edition to be displayed at the disposition location.

Further, in the example, in a case where the fourth edition is changed to the fifth edition, the figure included in the second chapter is changed, addition of texts “hi” is performed, and the change in the texts is performed.

Further, also in this case, the screen generation unit 302 determines the disposition location of the document image 90 indicating the fifth edition based on the amount of change in each of the figure and the text, and causes the document image 90 indicating the fifth edition to be displayed in the disposition location.

Further, in the example, similarly to the above, in a case where the second edition is changed to the third edition, the figure included in the second chapter is changed, and, accordingly, as indicated by reference numeral 16A, the document image 90 indicating the third edition is moved downward.

More specifically, in the third edition, the color of the figure is slightly changed, and, accordingly, the document image 90 indicating the third edition is moved downward. More specifically, in the third edition, the color of the figure is changed from the color of yellow-green to the color of green, and, accordingly, the document image 90 indicating the third edition is moved downward.

Further, in the example, in a case where the first edition is changed to the second edition, two texts of texts “de” are added to the second chapter, and, accordingly, as indicated by reference numeral 16B, the document image 90 indicating the second edition is moved downward by the amount corresponding to the two text.

Here, the example illustrated in FIG. 16A describes a case where both the text and the figure are changed.

In this case, the information acquisition unit 301 acquires the amount of change for each of the text and the figure, adds the amount of change for the text to the amount of change for the figure, and acquires the final amount of the change.

Note that, in a case where the amount of change is acquired, the information acquisition unit 301 may differentiate the amount of change acquired in a case where the text is changed and the amount of change acquired in a case where the figure is changed, according to a type of the target document.

For example, in a case where the type of the target document is a photo album, the information acquisition unit 301 may increase the value of the amount of change obtained in the case where the figure is changed and may reduce the value of the amount of change obtained in the case where the text is changed, compared to the case where the type of the target document is a text document.

In a case where the type of the target document is the photo album, a subject of the document is the figure, and a change in the figure greatly affects the document. On the other hand, an effect of the change in the text with respect to the document is relatively small.

In a case where the type of the target document is the photo album, the amount of change obtained in the case where the figure is changed is increased, and the amount of change obtained in the case where the text is changed is reduced, the change in the figure, which may largely change the impression of the document, appears prominently on the screen.

In addition, for example, in a case where the type of the target document is a text document, the information acquisition unit 301 may cause the value of the amount of change obtained in the case where the figure is changed to be small and may cause the value of the amount of change obtained in a case where the text is changed to be large, compared to the case where the type of the target document is the photo album.

For example, in a case where the target document is a legal document and the type of the target document is the text document, the subject of the document is the text, and the change in the text greatly affects the document. On the other hand, the effect of the change in the figure with respect to the document is relatively small.

As above, in a case where the type of the target document is the text document, the value of the amount of change obtained in the case where the text is changed is increased, and the amount of change obtained in the case where the figure is changed is reduced, the change in the text, which may largely change the impression of the document, appear more prominently on the screen.

In addition, in a case where the document is changed, the information acquisition unit 301 may acquire a value predetermined for each type of the document and may acquire information about the amount of change.

More specifically, in a case where the document is changed, the information acquisition unit 301 may acquire a value associated in advance with the type of the changed document, and may acquire the information about the amount of change.

More specifically, in a case where the processing is performed, the type of the document, the amount of change in a case where the text is changed, and the amount of change in a case where the figure is changed may be stored in the information storage unit 303 or the like in a state of being associated in advance for each type of the document.

Further, in a case where the document is changed, the information acquisition unit 301 recognizes the type of the document and recognizes whether a changed element is the figure or the text.

Further, the information acquisition unit 301 refers to the information storage unit 303, acquires a value corresponding to the recognized type and the recognized element, and recognizes the amount of change.

In addition, the amount of change corresponding to a predetermined value is determined for each of a plurality of types of elements configuring the document, and the information acquisition unit 301 may acquire the determined value for each of the elements to be changed, and may acquire information about the amount of change.

More specifically, for example, the elements configuring the document include the text and the figure as described above, and a predetermined value for the amount of change is determined for each of the text and the figure.

Further, the information acquisition unit 301 may acquire the predetermined value for each element that is changed, and may acquire information about the amount of change.

More specifically, for example, a value, which is acquired by the information acquisition unit 301 in a case where one text is deleted or one text is added, is determined in advance, and a value to be acquired by the information acquisition unit 301 in a case where one figure deleted or one figure is added is determined in advance.

Further, in a case where the text is deleted or added or the figure is deleted or added, the information acquisition unit 301 acquires the value predetermined for each element.

In addition, in the case where the text is deleted or added or the figure is deleted or added, the information acquisition unit 301 acquires the information about the amount of change based on the value predetermined for each of the elements.

Note that, in this case, for example, it is preferable to determine the value such that the value, which is acquired by the information acquisition unit 301 in the case where one figure is deleted or one figure is added, becomes larger than the value which is acquired by the information acquisition unit 301 in the case where one text is deleted or one text is added.

Generally, the change of one figure has a greater effect than the change of one text. In this manner, in a case where the value acquired by the information acquisition unit 301 is large in the case where one figure is deleted or one figure is added, the effect of the change in the figure appear more prominently on the screen.

In addition, the information acquisition unit 301 may acquire, for each element of a plurality of types of elements configuring the document, information about the time, at which the change is performed, and the amount of change, and, further, the screen generation unit 302 may generate the screen for each of the elements.

More specifically, the information acquisition unit 301 acquires the information about the time, at which the change is performed, and the amount of change for each text and each figure based on, for example, one document.

Further, the screen generation unit 302 generates each screen for each text and for each figure. Note that, at this time, in the screen generated to correspond to the text, the screen may be generated for each chapter as described above.

Others

In the above, although the case where the document of each edition of each of the plurality of users is stored in the external server 300 is described, the document of each edition may be stored in each of the terminal devices 100 owned by each user, and the document of each edition may be transmitted from the terminal device 100 to the external server 300 in a case where the screen is generated.

In addition, in the above, although the case where the processing is performed in the external server 300 is described, each processing described above may be performed in the terminal device 100 of each user.

In addition, in the above, the case where the document of each edition is stored in the external server 300 is described.

By the way, the present invention is not limited thereto. Whenever the document is changed, the information about the time, at which the change is performed, and the amount of change may be acquired, and, in a case where the information about the time, at which the change is performed, and the amount of change is acquired, the document of the old edition may be deleted.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
an information acquisition section that acquires, for each of a plurality of times of changes performed on a document, information about a time, at which a change is performed, and an amount of the change; and
a screen generation section that generates a screen in which information about each of the plurality of times of changes is displayed on a two-dimensional area using the time and the amount of change as axes.

2. The information processing system according to claim 1,
wherein the screen generation section generates a screen in which an image corresponding to each of the plurality of times of changes is displayed on the two-dimensional area.

3. The information processing system according to claim 2,
wherein the screen generation section generates a screen in which the image corresponding to each of the plurality of times of changes is displayed in a location corresponding to the time, at which the change is performed, and the amount of change in the two-dimensional area.

4. The information processing system according to claim 1,
wherein an edition of the document is updated by each of the plurality of times of changes performed on the document, and
wherein the screen generation section generates a screen in which an image corresponding to the document of each edition is displayed on the two-dimensional area.

5. The information processing system according to claim 1,
wherein the information acquisition section acquires the information about the amount of change based on an amount of change in the number of texts included in the document.

6. The information processing system according to claim 5,
wherein the information acquisition section acquires the information about an amount of the change based on the number of texts deleted from the document and/or the number of texts added to the document.

7. The information processing system according to claim 1,
wherein the information acquisition section acquires the information about the amount of change based on a change in an information amount of information of information included in the document.

8. The information processing system according to claim 1,
wherein the information acquisition section acquires a value determined for each element to be changed, and acquires the information about the amount of change.

9. The information processing system according to claim 8,
wherein the value, acquired by the information acquisition section in a case where the element to be changed includes figures and one figure is deleted, is larger than the value acquired by the information acquisition section in a case where the element to be changed includes texts and one text is deleted.

10. The information processing system according to claim 1,
wherein the screen generation section generates the screen in which the information about each of the plurality of times of changes is arranged at an equal interval in a time axis direction.

11. The information processing system according to claim 1,
wherein the information acquisition section acquires the information about a time, at which the change is performed, and an amount of the change, for a selection part selected by a user in the document, and
wherein the screen generation section generates a screen in which information about the change in the selection part is displayed on the two-dimensional area.

12. The information processing system according to claim 11,
wherein, in a case where a location of the selection part is changed in the document, the screen generation section generates the screen in which information indicating that the location is changed is further displayed.

13. The information processing system according to claim 1,
wherein the screen generation section generates the screen in which the information about each of the plurality of times of changes is displayed on the two-dimensional area and an image indicating a reference for the amount of change and/or an image indicating a reference for the time of change is displayed.

14. The information processing system according to claim 1,
wherein the information acquisition section acquires a predetermined value for each type of the document, and acquires information about the amount of change.

15. The information processing system according to claim 1,
wherein the information acquisition section acquires, for each element of a plurality of types of elements configuring the document, the information about the time, at which the change is performed, and the amount of change, and
wherein the screen generation section generates the screen for each of the elements.

16. An information processing apparatus, comprising:
an information acquisition section that acquires, for each of a plurality of times of changes performed on a document, information about a time, at which a change is performed, and an amount of the change; and
a screen generation section that generates a screen in which information about each of the plurality of times of changes is displayed on a two-dimensional area using the time and the amount of change as axes.

17. A non-transitory computer readable medium storing a program for causing a computer to realize
an information acquisition function of acquiring, for each of a plurality of times of changes performed on a document, information about a time, at which a change is performed, and an amount of the change; and
a screen generation function of generating a screen in which information about each of the plurality of times of changes is displayed on a two-dimensional area using the time and the amount of change as axes.
